(19) United States
(12) Patent Application Publication
(10) Pub. No.: US 2020/0372902 A1
(43) Pub. Date: Nov. 26, 2020

(54) LANGUAGE PRESENTATION DEVICE, LANGUAGE PRESENTATION METHOD, AND LANGUAGE PRESENTATION PROGRAM

(71) Applicant: PANASONIC INTELLECTUAL PROPERTY MANAGEMENT CO., LTD., Osaka (JP)

(72) Inventor: Mitsuru TAKAMI, Tokyo (JP)

(21) Appl. No.: 16/966,365

(22) PCT Filed: Jan. 18, 2019
(86) PCT No.: PCT/JP2019/001554

§ 371 Date: Jul. 30, 2020

(30) Foreign Application Priority Data
Jan. 30, 2018 (JP) 2018-013415

(51) Int. Cl. G10L 15/183; G10L 15/22; G06F 3/16; G09G 5/24; G09G 5/02; H04N 9/31; G03B 21/62

(52) U.S. Cl. CPC G10L 15/183; G10L 15/22; G06F 3/167; G09G 2354/00; G09G 5/02; H04N 9/31; G03B 21/62; G09G 5/24

(57) ABSTRACT

A language presentation device provided for conversation between a first user and a second user positioned facing each other across a transparent presentation unit. The language presentation device acquires a first speech uttered by at least one of the first user and the second user, acquires the content of the first speech and a translated content in which the content of the first speech is translated into a language suitable for the first user or the second user, and presents the content of the first speech and the translated content on the transparent presentation unit after horizontally flipping at least either of the two.

### TECHNICAL FIELD

The present disclosure relates to a language presentation device, a language presentation method, and a language presentation program for presenting a language on the basis of a recognition result of an uttered voice.

### BACKGROUND ART

Patent document 1 discloses a voice translation device that receives voices of at least two kinds of languages, recognizes the contents of the received voices, and translates the recognized contents into different languages. This voice translation device outputs a translated content in voice and displays, in different directions on the screen, a text of an input voice and a text of the translated content.

### CITATION LIST

### Patent Literature

Patent Document 1: WO 2017/086434

### SUMMARY OF INVENTION

### Object to be Attained by Invention

The concept of the present disclosure has been conceived in view of the above circumstances in the art, and an object of the disclosure is to provide a language presentation device, a language presentation method, and a language presentation program that allow two persons who cannot understand each other's language to make a conversation while continuing to look at each other's face by presenting languages of them toward their respective faces and to thereby realize, in a simplified manner, a natural and smooth conversation.

### Solution to Problem

The present disclosure provides a language presentation device including a first acquisition unit configured to acquire a first voice uttered by at least one of a first user and a second user who are located with a transparent presentation unit interposed between the first user and the second user; a second acquisition unit configured to acquire a content of the acquired first voice and a translated content obtained by translating the content of the first voice into a language suitable for the first user or the second user; and a control unit configured to present the acquired content of the first voice and the acquired translated content on the transparent presentation unit in such a manner that one of the acquired content of the first voice and the acquired translated content is inverted in a left-right direction.

The disclosure provides a language presentation method employed in a language presentation device that serves for a conversation between a first user and a second user located with a transparent presentation unit interposed between them, including the steps of acquiring a first voice uttered by at least one of a first user and a second user; acquiring a content of the acquired first voice and a translated content obtained by translating the content of the first voice into a language suitable for the first user or the second user; and presenting the acquired content of the first voice and the acquired translated content on the transparent presentation unit in such a manner that one of the acquired content of the first voice and the acquired translated content is inverted in a left-right direction.

The disclosure also provides a language presentation program for causing a language presentation device that is a computer and serves for a conversation between a first user and a second user located with a transparent presentation unit interposed between the first user and the second user to execute the steps of acquiring a first voice uttered by at least one of a first user and a second user; acquiring a content of the acquired first voice and a translated content obtained by translating the content of the first voice into a language suitable for the first user or the second user; and presenting the acquired content of the first voice and the acquired translated content on the transparent presentation unit in such a manner that one of the acquired content of the first voice and the acquired translated content is inverted in a left-right direction.

Furthermore, the disclosure provides a language presentation device including a transparent presentation unit; an acquisition unit configured to acquire a first voice uttered by a user in a first language; and a control unit configured to present a content of the acquired first voice and a second content obtained by translating the content of the first voice into a second language that is different from the first language on the transparent presentation unit in such a manner that the content of the acquired first voice and the translated content are inverted from each other in a left-right direction.

Still further, the disclosure provides a language presentation program for causing a language presentation device that is a computer connected to a transparent presentation unit to execute the steps of acquiring a first voice uttered by a user in a first language; acquiring a content of the acquired first voice and a translated second content obtained by translating the content of the first voice into a second language that is different from the first language; and presenting the acquired content of the first voice and the acquired second content on the transparent presentation unit in such a manner that the content of the acquired first voice and the translated content are inverted from each other in a left-right direction.

### Advantageous Effects of Invention

The present disclosure allows two persons who cannot understand each other's language to make a conversation while continuing to look at each other's face by presenting languages of them toward their respective faces and thereby realizes, in a simplified manner, a natural and smooth conversation.

### BRIEF DESCRIPTION OF DRAWINGS

FIG. 1 is a block diagram showing, in detail, an example system configuration of a language presentation system according to a first embodiment.

FIG. 2 is an explanatory diagram showing an example use of the language presentation system by a host and a guest.

FIG. 3 is an explanatory diagram outlining an example operation that the language presentation system performs after being triggered by a voice of a host uttered at time t1.

FIG. 4 is an explanatory diagram outlining an example operation that the language presentation system performs at time t2 that is after the timing of FIG. 3.

FIG. 5 is an explanatory diagram outlining an example operation that the language presentation system performs at time t3 that is after the timing of FIG. 4.

FIG. 6 is an explanatory diagram outlining an example operation that the language presentation system performs at time t4 that is after time t3.

FIG. 7 is an explanatory diagram outlining an example operation that the language presentation system performs at time t5 that is after the timing of FIG. 6.

FIG. 8 is a sequence diagram illustrating, in detail, an example operation procedure of the language presentation system according to the first embodiment.

### DESCRIPTION OF EMBODIMENT

### Background Leading to Embodiment 1

The configuration of the above-described Patent document 1 may be able to realize a smooth conversation between two persons by causing them to look at respective pictures even if each person cannot understand the language of the other. However, in Patent document 1, the two persons who cannot understand each other's language need to look at the screen of the voice translation device by turning their eyes from each other's face (e.g., eyes) during a conversation between them. As a result, a person who is accustomed to making a conversation while looking at the eyes of the other person (e.g., a foreigner who has come to Japan for sightseeing, business, or the like) would feel uncomfortable and have difficulty making a conversation naturally and smoothly.

The first embodiment described below has been conceived in view of the above circumstances in the art, and will describe a language presentation device, a language presentation method, and a language presentation program that allow two persons who cannot understand each other's language to make a conversation while continuing to look at each other's face by presenting languages of them toward their respective faces and to thereby realize, in a simplified manner, a natural and smooth conversation.

The embodiment in which a language presentation device, a language presentation method, and a language presentation program according to the disclosure will be disclosed in a specific manner will be described in detail by referring to the accompanying drawings when necessary. However, unnecessarily detailed descriptions may be avoided. For example, detailed descriptions of already well-known items and duplicated descriptions of constituent elements having substantially the same ones already described may be omitted. This is to prevent the following description from becoming unnecessarily redundant and thereby facilitate understanding of those skilled in the art. The following description and the accompanying drawings are provided to allow those skilled in the art to understand the disclosure thoroughly and are not intended to restrict the subject matter set forth in the claims.

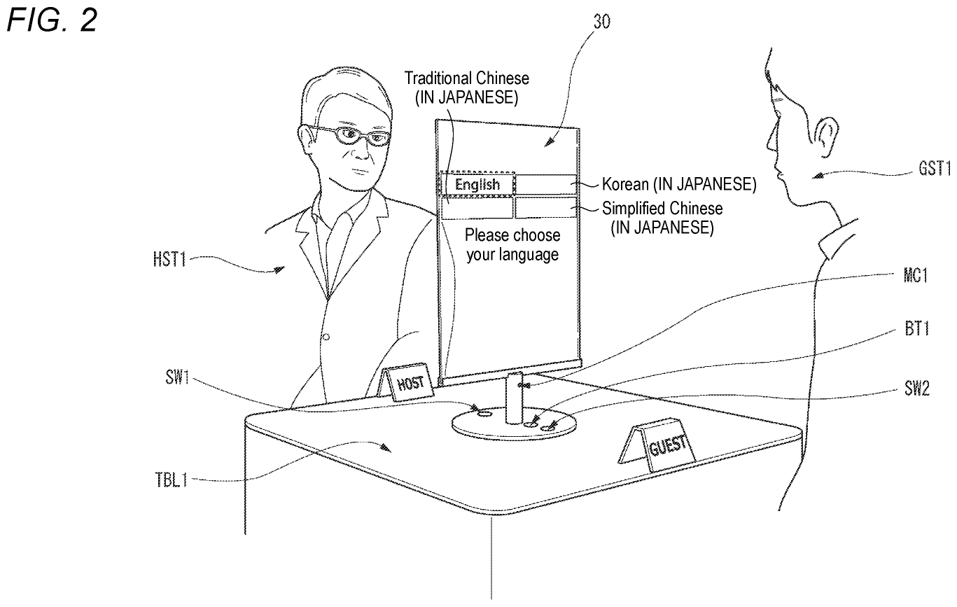

In the following, an example that a language presentation system including the language presentation according to the disclosure is used for (e.g., assists) a conversation that a host and a guest who cannot understand each other's language make while facing each other looking at each other's face with a transparent screen located between them on a counter such as a reception counter (see FIG. 2) will be described as an example case of use of the language presentation system. In the following embodiment, a host-guest relationship (that is, a relationship between a service providing side and a service receiving side) need not always hold between users of the language presentation system; for example, the language presentation system may likewise be applied to users who are in equal positions.

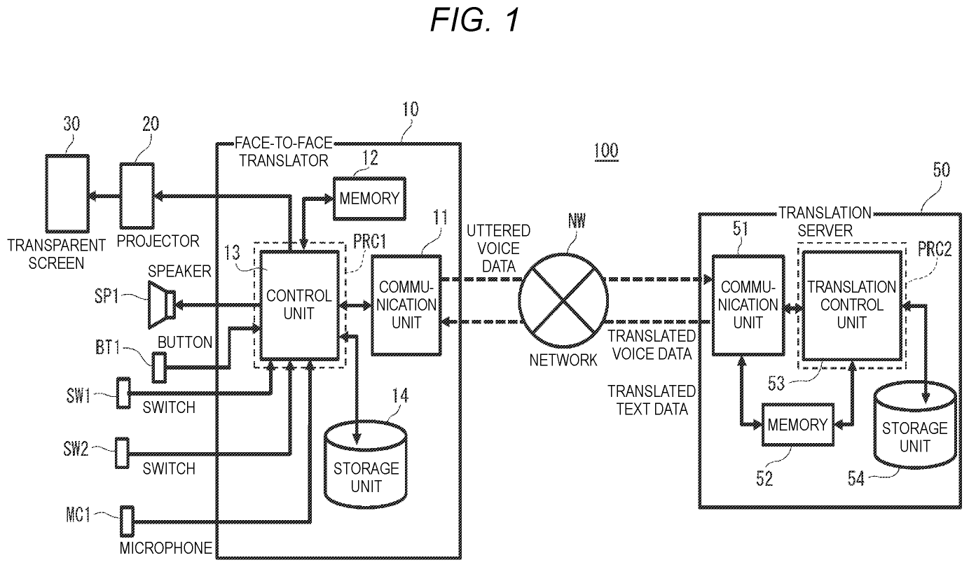

FIG. 1 is a block diagram showing, in detail, an example system configuration of a language presentation system 100 according to the first embodiment. FIG. 2 is an explanatory diagram showing an example use of the language presentation system 100 by a host HST1 and a guest GST1. As shown in FIG. 2, the host HST1 and the guest GST1 who are users of the language presentation system 100 and cannot understand each other's language (e.g., native language) make a conversation while facing each other looking at each other's face with a transparent screen 30 installed between them in a stationary manner on a table TBL1 such as a counter.

The language presentation system 100 shown in FIG. 1 is configured so as to be equipped with a face-to-face translator 10, a projector 20, a transparent screen 30, a button BT1, switches SW1 and SW2, a microphone MC1, a speaker SP1, and a translation server 50. The face-to-face translator 10 and the translation server 50 are connected to each other via a network NW that uses a wired or wireless communication channel.

The face-to-face translator 10 (an example of a term “language presentation device”) is configured so as to include a communication unit 11, a memory 12, a control unit 13, and a storage unit 14. The face-to-face translator 10 is configured using an information processing device that is a computer such as a server or a PC (personal computer) and is installed at, for example, such a position as to be recognized visually by neither the host HST1 nor the guest GST1 (e.g., inside a counter (not shown) or in a backyard monitoring room (not shown)). The face-to-face translator 10 assists a conversation between the host HST1 and the guest GST1 who face each other with the transparent screen 30 located between them.

The communication unit 11, which serves as a communication interface for a communication with the translation server 50, transmits data (hereinafter referred to as “uttered voice data”) of a voice (described later) picked up by the microphone MC1 to the translation server 50 over the network NW. The communication unit 11 receives, over the network NW, translated text data and translated voice data transmitted from the translation server 50. The communication unit 11 may store data or information acquired by itself in the memory 12 temporarily.

The memory 12, which is configured using, for example, a RAM (random access memory) and a ROM (read-only memory), temporarily holds programs and data that are necessary for operation of the face-to-face translator 10 and data or information generated during an operation of the face-to-face translator 10. The RAM is a work memory that is used, for example, during an operation of the face-to-face translator 10. The ROM stores and holds, in advance, programs and data for, for example, controlling the face-to-face translator 10.

The memory 12 holds information relating to a language (e.g., Japanese) used by the host HST1 and information relating to a language (e.g., English) used by the guest GST1 in such a manner that they are correlated with each other. The information relating to the language used by the host HST1 may be either recorded in, for example, the ROM in advance or stored in the memory 12 as information that is set every time a manipulation is made (e.g., the button BT1 for language selection is pushed) by the host HST1. The information relating to the language used by the guest GST1 is stored in the memory 12 as information that is set every time a manipulation is made (e.g., the button BT1 for language selection is pushed) by the guest GST1. FIG. 2 illustrates a situation that information relating to a language used by the guest GST1 is being set on the transparent screen 30. For example, the guest GST1 switches between kinds of languages (e.g., English, Korean, Traditional Chinese, and Simplified Chinese) projected onto the transparent screen 30 from the projector 20 by pushing the button BT1 for a short time and selects his own language by pushing the button BT1 for a long time. Although this example employs English, Korean, Traditional Chinese, and Simplified Chinese, the kinds of languages to be projected are not limited to these languages and, for example, kinds of languages corresponding to information relating to usable languages registered in the memory 12 in advance may be presented on the transparent screen 30 in a selectable manner. In FIG. 2, “English” is highlighted to indicate a state that it is selected temporarily as one option or a state that it is selected finally. A signal indicating information relating to a language used by the guest GST1 that has been selected by manipulations on the button BT1 made by the guest GST1 is input to the face-to-face translator 10 and registered in the memory 12. The manner of setting information relating to a language is not limited to the above-described example.

The memory 12 holds information indicating a projection position, on the transparent screen 30, of first text data obtained by character-recognizing the content of a voice (an example of a term “first voice”) uttered by the host HST1 (i.e., information indicating a height of presentation of the first text data on the transparent screen 30).

Likewise, the memory 12 holds information indicating a projection position, on the transparent screen 30, of second text data obtained by character-recognizing the content of a voice (an example of a term “second voice”) uttered by the guest GST1 (i.e., information indicating a height of presentation of the second text data on the transparent screen 30).

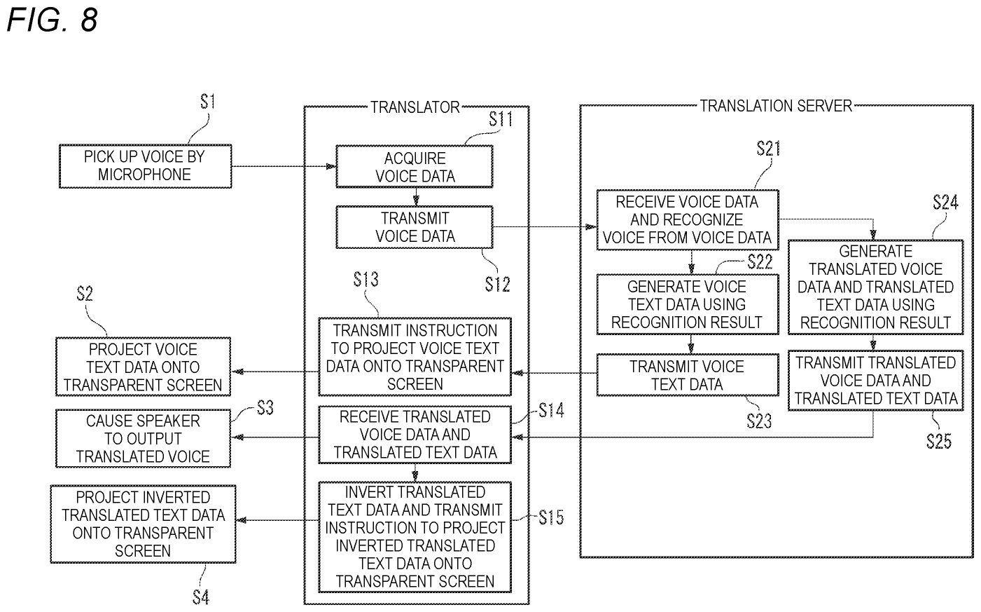

For example, the control unit 13 is a processor PRC1 that is configured using a CPU (central processing unit), an MPU (microprocessing unit), a DSP (digital signal processor), or an FPGA (field programmable gate array). Functioning as a controller for controlling the operation of the face-to-face translator 10, the control unit 13 performs control processing for supervising operations of individual units of the face-to-face translator 10 comprehensively, data input/output processing with the individual units of the face-to-face translator 10, data computation (calculation) processing, and data storage processing. The control unit 13 operates according to programs and data stored in the memory 12. Using the memory 12 during an operation, the control unit 13 may store data or information generated or acquired by the control unit 13 in the memory 12 temporarily. The details of the operation of the control unit 13 will be described later with reference to FIG. 8.

The storage unit 14 is a storage device that is configured using an HDD (hard disk drive) or an SSD (solid-state drive), for example. For example, the storage unit 14 stores data or information generated or acquired by the control unit 13. The storage unit 14 may be omitted in the configuration of the face-to-face translator 10.

The projector 20 (an example of a term “transparent presentation unit”) is connected to the face-to-face translator 10 so as to be able to transmit and receive data or information to and from the face-to-face translator 10. The projector 20 is disposed so as to be opposed to the transparent screen 30. When receiving and acquiring data of a projection image including a projection instruction transmitted from the face-to-face translator 10, the projector 20 generates, on the basis of the projection instruction, projection light (e.g., visible light) for projection, onto the transparent screen 30, of the projection image specified by the projection information and projects it toward the transparent screen 30. In this manner, the projector 20 can project, onto the transparent screen 30, a projection image (e.g., text data corresponding to a voice uttered by the host HST1 or the guest GST1) specified by the face-to-face translator 10 and thereby assist a conversation between the host HST1 and the guest GST1.

The transparent screen 30 (an example of the term “transparent presentation unit”) has a structure that, for example, a sheet on which a projection light coming from the projector 20 is to be projected is bonded to a transparent glass plate and is installed in a stationary manner. Projection light (e.g., visible light) coming from the projector 20 is projected onto the transparent screen 30, and the transparent screen 30 presents, to both of the host HST1 and the guest GST1, a projection image for assisting a conversation between the host HST1 and the guest GST1 (e.g., text data corresponding to a voice uttered by the host HST1 or the guest GST1). The transparent screen 30 does not always require the projector 20. For example, it is preferable that the transparent screen 30 be a transparent display whose transparency is higher than or equal to about 40% and it is particularly preferable that its transparency be higher than or equal to about 70%. The transparent screen 30 may be a transparent liquid crystal display, a transparent organic EL display, or the like having such a characteristic.

Furthermore, the transparent screen 30 may be a transparent screen (refer to Referential Non-patent Document 1, for example) in which switching can be made between a transparent mode and a screen mode alternately.

### Referential Non-patent Document 1

Panasonic Corporation, “Transparent Screen,” [online], [Searched on Jan. 22, 2018], Internet <URL: http://panasonic.biz/cns/invc/screen/technology.html>.

In the first embodiment, a transparent touch panel that can display data or information supplied from the face-to-face translator 10 and detect a direct manipulation, such as a touch, of the host HST1 and the guest GST1 may be provided in place of the projector 20 and the transparent screen 30 as an example transparent presentation unit.

The button BT1 is a language selection button to be used for setting information relating to languages used by the host HST1 and the guest GST1 and, as shown in FIG. 2, for example, is provided approximately at a center portion of a circular stage of the transparent screen 30 installed on the table TBL1 so as to be able to be pushed. A projection image for language selection for the guest GST1 is projected on the transparent screen 30 shown in FIG. 2, and, for example, the guest GST1 selects a language to be used by himself (e.g., the native language of the guest GST1) by pushing the button BT1. The button BT1 may be provided either at a position that is closer to the side of the guest GST1 than the side of the host HST1 so as to allow the guest GST1 to push it easily (see FIG. 2) or a position that is approximately equally distant from the host HST1 and the guest GST1.

The switch SW1 is a switch that is pushed by the host HST1 to inform the face-to-face translator 10 of timing of utterance of the host HST1. In other words, the switch SW1 is pushed by the host HST1 immediately before utterance of the host HST1. This allows the face-to-face translator 10 to recognize the timing when the host HST1 has spoken on the basis of a signal received from the switch SW1.

The switch SW2 is a switch that is pushed by the guest GST1 to inform the face-to-face translator 10 of timing of utterance of the guest GST1. In other words, the switch SW2 is pushed by the guest GST1 immediately before utterance of the guest GST1. This allows the face-to-face translator 10 to recognize the timing when the guest GST1 has spoken on the basis of a signal received from the switch SW2.

The microphone MC1 picks up a voice uttered by one of the host HST1 and the guest GST1 who is speaking alternately and sends a signal indicating the picked up voice to the face-to-face translator 10. To make it easier to pick up a voice of the guest GST1 than a voice of the host HST1, the microphone MC1 may be installed on the stage of the transparent screen 30 so as to be directed to the side of the guest GST1. Alternatively, to equally pick up a voice uttered by the host HST1 and a voice uttered by the guest GST1, the microphone MC1 may be installed on the stage of the transparent screen 30 so as to be equally distant from the host HST1 side and the guest GST1 side.

The speaker SP1 receives a signal of voice data that is output from the face-to-face translator 10 and outputs a corresponding voice. For example, a signal of voice data that is input to the speaker SP1 is one of a signal indicating voice data of a voice uttered by the host HST1, a signal indicating voice data of a voice uttered by the guest GST1, a signal indicating voice data of a result of translation, into a language suitable for the guest GST1, of the content of a voice uttered by the host HST1 (i.e., translated voice data), and a signal indicating voice data of a result of translation, into a language suitable for the host HST1, of the content of a voice uttered by the guest GST1 (i.e., translated voice data).

The translation server 50 (an example of the term “language presentation device”) is configured so as to include a communication unit 51, a memory 52, a translation control unit 53, and a storage unit 54. The translation server 50 is a cloud server that is configured using an information processing device that is a computer such as a server or a PC, and is connected to the face-to-face translator 10 via the network NW. When receiving and acquiring voice data from the face-to-face translator 10, the translation server 50 character-recognizes a voice corresponding to the acquired voice data and performs translation processing on the acquired voice. The translation server 50 transmits, to the face-to-face translator 10, text data as a character recognition result (hereinafter referred to as “recognized text data”), text data as a translation processing result (hereinafter referred to as “translated text data”), and voice data as a translation processing result (hereinafter referred to as “translated voice data”).

The communication unit 51, which serves as a communication interface for a communication with the face-to-face translator 10, transmits recognized text data, translated text data, and translated voice data as mentioned above to the face-to-face translator 10 over the network NW. The communication unit 11 receives, over the network NW, uttered voice data transmitted from the face-to-face translator 10. The communication unit 51 may store, temporarily, data or information acquired by itself in the memory 52.

The memory 52, which is configured using, for example, a RAM and a ROM, temporarily holds programs and data that are necessary for operation of the translation server 50 and data or information generated during an operation of the translation server 50. The RAM is a work memory that is used, for example, during an operation of the translation server 50. The ROM stores and holds, in advance, programs and data for, for example, controlling the translation server 50.

For example, the translation control unit 53 is a processor PRC2 configured using a CPU, an MPU, a DSP, or an FPGA. Functioning as a controller for controlling the operation of the translation server 50, the translation control unit 53 performs control processing for supervising operations of individual units of the translation server 50 comprehensively, data input/output processing with the individual units of the translation server 50, data computation (calculation) processing, and data storage processing. The translation control unit 53 operates according to programs and data stored in the memory 52. Using the memory 52 during an operation, the translation control unit 53 may store data or information generated or acquired by the translation control unit 53 in the memory 52 temporarily. The details of the operation of the translation control unit 53 will be described later with reference to FIG. 8.

The storage unit 54 is a storage device configured using an HDD or an SSD, for example. For example, the storage unit 54 stores data of information acquired by the translation control unit 53. Furthermore, the storage unit 54 holds a dictionary DB (database) to be used by the translation control unit 53 in performing translation processing on recognized text data. Still further, the storage unit 54 holds a voice DB to be used by the translation control unit 53 to generate voice data (that is, translated voice data) corresponding to translated text data. The translation server 50 may update the contents of the above-mentioned dictionary DB and voice DB on a regular basis by, for example, communicating with, on a regular basis, an external dictionary server (not shown) that is connected via the network NW.

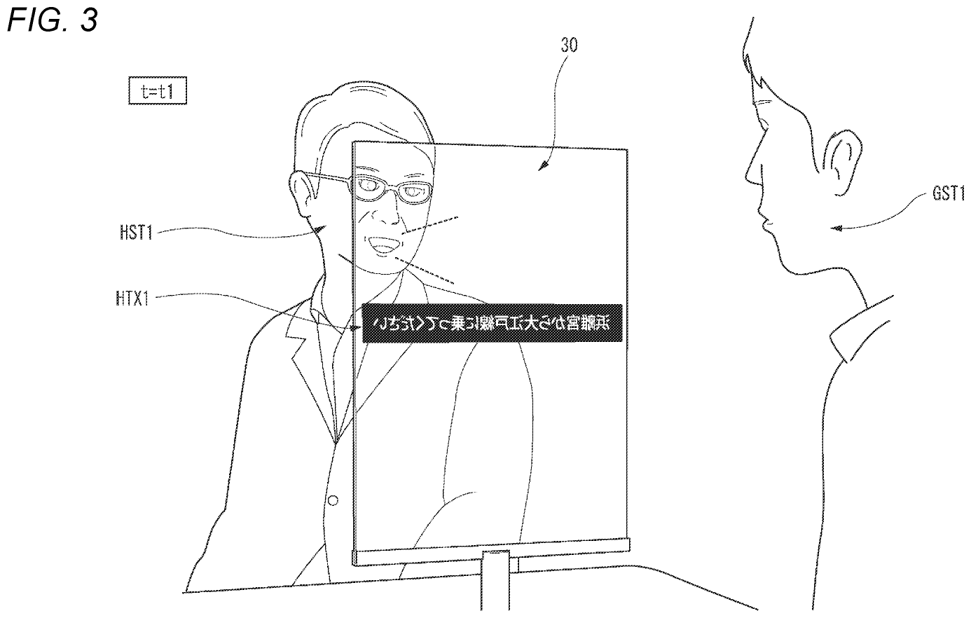

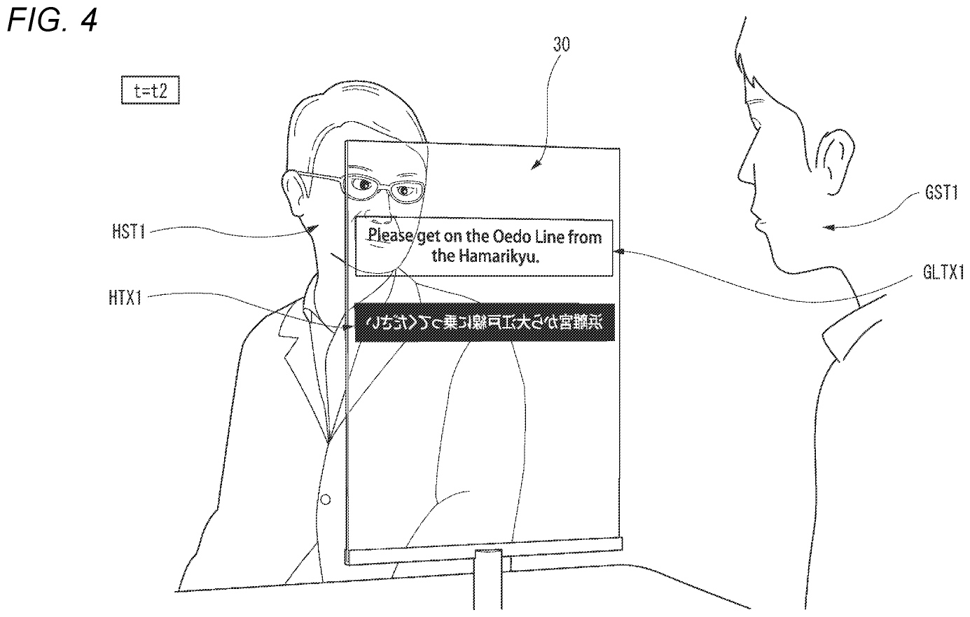

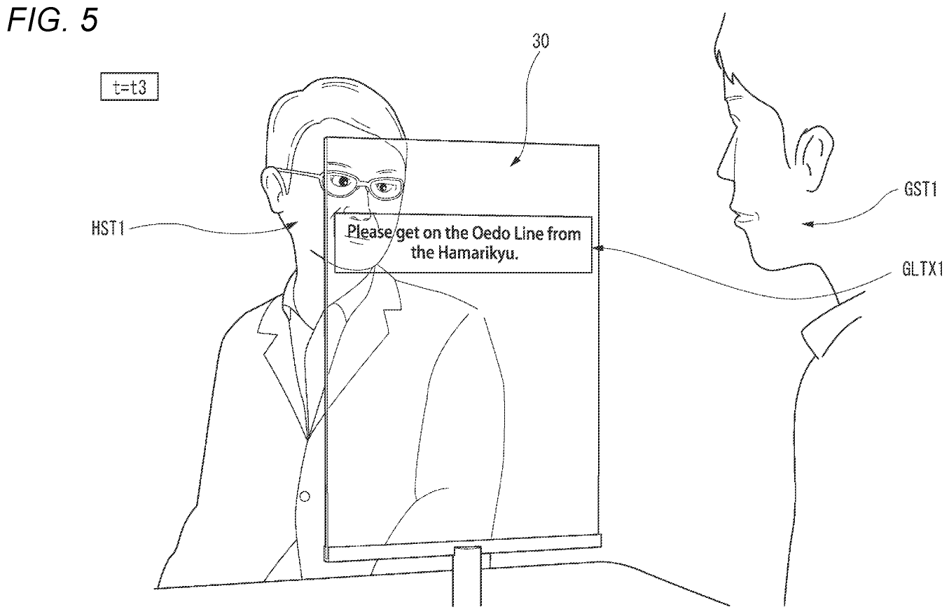

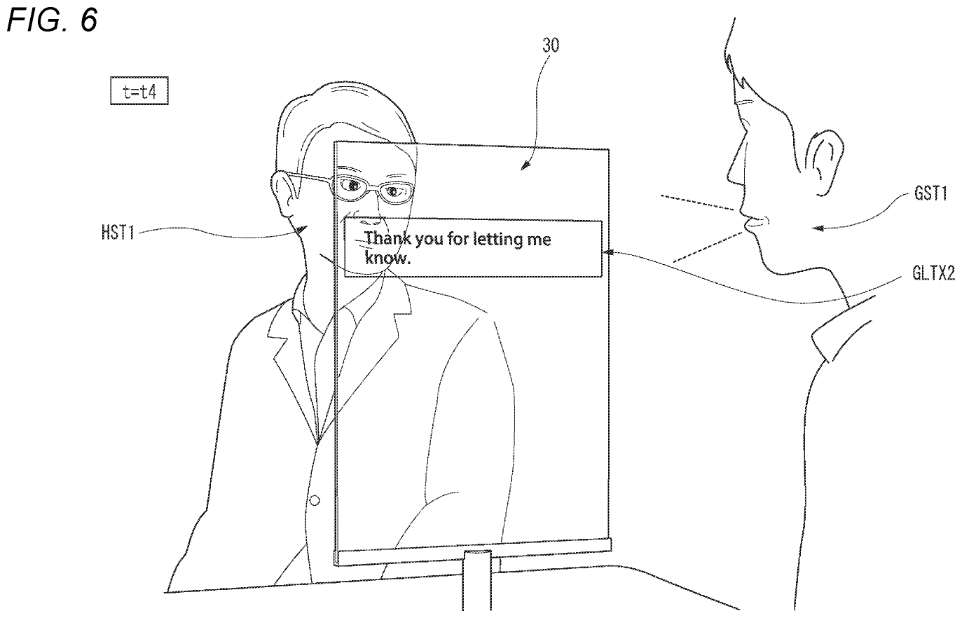

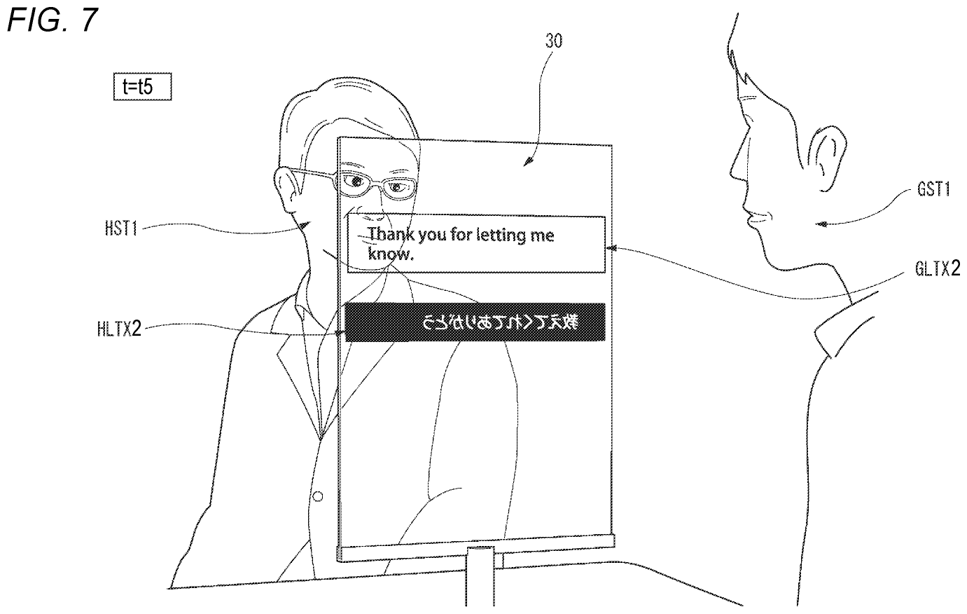

Next, how the language presentation system 100 according to the first embodiment operates will be outlined with reference to FIGS. 3-7. FIG. 3 is an explanatory diagram outlining an example operation that the language presentation system 100 performs after being triggered by a voice of the host HST1 uttered at time t1. FIG. 4 is an explanatory diagram outlining an example operation that the language presentation system 100 performs at time t2 that is after the timing of FIG. 3. FIG. 5 is an explanatory diagram outlining an example operation that the language presentation system 100 performs at time t3 that is after the timing of FIG. 4. FIG. 6 is an explanatory diagram outlining an example operation that the language presentation system 100 performs at time t4 that is after time t3. FIG. 7 is an explanatory diagram outlining an example operation that the language presentation system 100 performs at time t5 that is after the timing of FIG. 6. FIGS. 3-7 are drawn in such a manner that the main direction is in the line of sight of the guest GST1, for example.

Referring to FIG. 3, assume that at time t=t1 the host HST1 pushes the switch SW1 and says “Please get on the Oedo Line from the Hamarikyu” (in Japanese). When the voice of “Please get on the Oedo Line from the Hamarikyu” (in Japanese) said by the host HST1 has been picked up by the microphone MC1, the face-to-face translator 10 acquires data of that voice (uttered voice data) from the microphone MC1 and transmits it to the translation server 50. The translation server 50 performs character recognition processing on the uttered voice data transmitted from the face-to-face translator 10, generates recognized text data as its character recognition result (i.e., text data of “ [symbol] [symbol] (in Japanese language)”) and transmits it to the face-to-face translator 10. The face-to-face translator 10 receives and acquires the recognized text data transmitted from the translation server 50. The face-to-face translator 10 presents the recognized text data HTX1 to the host HST1 by projecting it on the transparent screen 30 via the projector 20.

Then, as shown in FIG. 4, at time t=t2 that is after t=t1, the translation server 50 performs translation processing on the recognized text data as the character recognition result and thereby generates translated text data (i.e., text data of “Please get on the Oedo Line from the Hamarikyu” (English)) by referring to the dictionary DB stored in the storage unit 54. Furthermore, at time t=t2, the translation server 50 generates voice data (translated voice data) corresponding to the translated text data. The translation server 50 transmits the translated text data and the translated voice data to the face-to-face translator 10 in such a manner that they are correlated with each other. The face-to-face translator 10 receives and acquires the translated text data and the translated voice data transmitted from the translation server 50. The face-to-face translator 10 presents the translated text data GLTX1 to the guest GST1 by projecting it onto the transparent screen 30 via the projector 20 in a state that it is inverted in the left-right direction from the direction in which the recognized text data HTX1 is being presented on the transparent screen 30. Still further, at time t=t2, the face-to-face translator 10 causes the speaker SP1 to output the translated voice data. The timing at which the translation server 50 generates translated text data and translated voice data may be time t1 (earlier timing) rather than time t2. As shown in FIG. 4, at time t2, the face-to-face translator 10 may present at least the translated text data GLTX1 to the guest GST1 by projecting it onto the transparent screen 30 via the projector 20 in a state that it is inverted in the left-right direction from the direction in which the recognized text data HTX1 is being presented on the transparent screen 30.

Then, as shown in FIG. 5, at time t=t3 that is after time t=t2, the face-to-face translator 10 instructs the projector 20 to stop projecting the recognized text data HTX1 so that the projection of the recognized text data HTX1 that were started at time t=t2 will be stopped earlier than the projection of the translated text data GLTX1. As a result, after time t=t3 that is after time t=t2, the translated text data GLTX1 to be presented to the guest GST1 continues to be projected on the transparent screen 30 (i.e., it is projected for a long time), which allows the face-to-face translator 10 to assist the guest GST1 more kindly than the host HST1 when they make a conversation.

Then, assume that at time t=t4 that is after time t=t3 the guest GST1 pushes the switch SW2 and says “Thank you for letting me know” (in English). When the voice of “Thank you for letting me know” said by the guest GST1 has been picked up by the microphone MC1, the face-to-face translator 10 acquires data of that voice (uttered voice data) from the microphone MC1 and transmits it to the translation server 50. The translation server 50 performs character recognition processing on the uttered voice data transmitted from the face-to-face translator 10, generates recognized text data as its character recognition result (i.e., text data of “Thank you for letting me know” (English)) and transmits it to the face-to-face translator 10. The face-to-face translator 10 receives and acquires the recognized text data transmitted from the translation server 50. The face-to-face translator 10 presents the recognized text data GLTX2 to the guest GST1 by projecting it onto the transparent screen 30 via the projector 20.

Then, as shown in FIG. 7, at time t=t5 that is after t=t4, the translation server 50 performs translation processing on the recognized text data as the character recognition result and thereby generates translated text data (i.e., text data of “ [symbol] (in Japanese language)”) by referring to the dictionary DB stored in the storage unit 54. Furthermore, at time t=t5, the translation server 50 generates voice data (translated voice data) corresponding to the translated text data. The translation server 50 transmits the translated text data and the translated voice data to the face-to-face translator 10 in such a manner that they are correlated with each other. The face-to-face translator 10 receives and acquires the translated text data and the translated voice data transmitted from the translation server 50. The face-to-face translator 10 presents the translated text data HLTX2 to the host HST1 by projecting it onto the transparent screen 30 via the projector 20 in a state that it is inverted in the left-right direction from the direction in which the recognized text data GLTX2 is being presented on the transparent screen 30. Still further, at time t=t5, the face-to-face translator 10 causes the speaker SP1 to output the translated voice data. The timing at which the translation server 50 generates translated text data and translated voice data may be time t4 (earlier timing) rather than time t5. As shown in FIG. 7, at time t5, the face-to-face translator 10 may present at least the translated text data HLTX2 to the host HST1 by projecting it onto the transparent screen 30 via the projector 20 in a state that it is inverted in the left-right direction from the direction in which the recognized text data GLTX2 is being presented on the transparent screen 30.

Next, an operation procedure of the language presentation system 100 according to the first embodiment will be described with reference to FIG. 8. FIG. 8 is a sequence diagram illustrating, in detail, an example operation procedure of the language presentation system 100 according to the first embodiment. One assumption of the description to be made with reference to FIG. 8 is that information relating to a language (e.g., Japanese) used by the host HST1 (an example of the term “first user”) who is a user of the language presentation system 100 and information relating to a language (e.g., English) used by the guest GST1 (an example of the term “second user”) are known in the face-to-face translator 10 and the translation server 50. Furthermore, the operation procedure shown in FIG. 8 is effective irrespective of whether which of the host HST1 and the guest GST1 speaks first.

Referring to FIG. 8, one of the host HST1 and the guest GST1 who is going to speak to make a conversation pushes the switch SW1 or the switch SW2. A signal to the effect that the switch has been pushed is input to the control unit 13 via the communication unit 11 of the face-to-face translator 10. The microphone MC1 takes voice data of a voice uttered by the host HST1 or the guest GST1 (S1).

The control unit 13 (an example of a term “first acquisition unit”) of the face-to-face translator 10 acquires, by receiving it via the communication unit 51, the audio data of the voice (an example of the term “first voice”) picked up by the microphone MC1 at step S1 (S11). Capable of recognizing, immediately before the time point of step S11, which switch has been pushed, the control unit 13 of the face-to-face translator 10 can recognize by which of the host HST1 and the guest GST1 the voice of the voice data acquired at the time point of step S11 was uttered. Since the control unit 13 of the face-to-face translator 10 has recognized in advance what languages the host HST1 and the guest GST1 use, the control unit 13 may infer which of the host HST1 and the guest GST1 has spoken by, for example, inferring a language of the uttered voice data by performing a known language inference processing using the uttered voice data.

The communication unit 11 of the face-to-face translator 10 transmits the voice data (i.e., uttered voice data) acquired at step S11 to the translation server 50 (S12). In the case of a setting that the translation control unit 53 of the translation server 50 has not recognized information relating to a language (e.g., Japanese) used by the host HST1 and information relating to a language (e.g., English) used by the guest GST1, for example, the communication unit 11 of the face-to-face translator 10 may transmit information relating to the respective languages used by the host HST1 and the guest GST1 to the translation server 50 together with the uttered voice data. This allows the translation control unit 53 of the translation server 50 to recognize from what language to what language a translation should be made on the basis of the language-related information that has been transmitted from the face-to-face translator 10 at the time point of step S12.

The translation control unit 53 of the translation server 50 receives and acquires the uttered voice data transmitted from the face-to-face translator 10 at step S12 and performs known character recognition processing on the acquired uttered voice data (S21). Using a result of the character recognition processing obtained at step S21, the translation control unit 53 of the translation server 50 generates recognized text data that is character-recognized data of the content of the uttered voice data (S22). The communication unit 51 of the translation server 50 transmits the recognized text data generated at step S22 to the face-to-face translator 10 (S23).

The translation control unit 53 of the translation server 50 generates translated text data by performing translation processing on the character recognition result obtained at step S21 into a language suitable for the host HST1 or the guest GST1 by referring to the dictionary DB stored in the storage unit 54 (S24). Furthermore, the translation control unit 53 of the translation server 50 generates translated voice data that is a connection of voice data corresponding to respective text data (e.g., words and sentences) in the translated text data and is suitable for the host HST1 or the guest GST1 by referring to the voice DB stored in the storage unit 54 (S24). The communication unit 51 of the translation server 50 transmits both of the translated text data and the translated voice data generated at step S24 to the face-to-face translator 10 (S25).

The translation control unit 53 of the translation server 50 may execute steps S22 and S23 and steps S24 and S25 either in parallel or in order of steps S22, S23, S24, and S25 after the execution of step S21.

Although it was described above with reference to FIG. 8 that the individual steps S21-S25 are executed by the external server (i.e., translation server 50) that is different from the face-to-face translator 10, in the first embodiment all or part of steps S21-S25 may be executed by the face-to-face translator 10, for example. This makes it possible to omit (part of) the configuration of the translation server 50 or reduce the processing amount of the translation server 50. As a result, since the amount of data communications performed between the face-to-face translator 10 and the translation server 50 over the network NW can be reduced or the entire process shown in FIG. 8 can be executed fully only by the face-to-face translator 10, the language presentation system 100 can effectively assist a conversation between the host HST1 and the guest GST1 with high reactivity.

The communication unit 11 (an example of a term “second acquisition unit”) of the face-to-face translator 10 receives and acquires the recognized text data that is transmitted from the translation server 50 at step S23 (S13). The control unit 13 of the face-to-face translator 10 generates a first projection instruction to project the recognized text data onto the transparent screen 30 and transmits the first projection instruction including the recognized text data to the projector 20 via the communication unit 11 (S13). The projector 20 projects the recognized text data onto the transparent screen 30 in such a manner that the host HST1 and the guest GST1 can see it on the basis of the first projection instruction received from the face-to-face translator 10 (S2).

Furthermore, the communication unit 11 of the face-to-face translator 10 receives and acquires the translated text data and the translated voice data transmitted from the translation server 50 at step S25 (S14). The translated text data indicates the content of a translated voice (an example of a term “second voice”) obtained by translating the content of the voice of uttered voice data into a language suitable for the host HST1 or the guest GST1. The translated voice data is voice data that is a connection of voice data corresponding to respective words constituting the translated text data and is suitable for the host HST1 or the guest GST1. The control unit 13 of the face-to-face translator 10 outputs the translated voice data to the speaker SP1 and thereby presents a translated voice representing the content of the translated voice data to the host HST1 or the guest GST1 by causing the speaker SP1 to output it (S3).

The control unit 13 of the face-to-face translator 10 generates a second projection instruction to project the translated text data in a state that it is inverted in the left-right direction from the direction in which the recognized text data is being presented on the transparent screen 30 and transmits the second projection instruction including the translated text data to the projector 20 via the communication unit 11 (S15). The projector 20 projects the translated text data onto the transparent screen 30 in such a manner that the host HST1 and the guest GST1 can see it on the basis of the second projection instruction received from the face-to-face translator 10 (S4).

As described above, in the language presentation system 100 according to the first embodiment, the face-to-face translator 10 acquires uttered voice data of a voice uttered by at least one of the host HST1 and the guest GST1 who are facing each other with the transparent screen 30 interposed between them. The face-to-face translator 10 acquires the voice content of the acquired uttered voice data and the voice content of translated voice data obtained by translating the voice content of the uttered voice data into a language suitable for the host HST1 or the guest GST1. The face-to-face translator 10 presents the acquired voice content of the uttered voice data and the acquired voice content of the translated voice data on the transparent screen 30 in such a manner that one of them is inverted in the left-right direction.

Configured in the above-described manner, the language presentation system 100 allows two persons who cannot understand each other's language to make a conversation while continuing to look at each other's face by presenting languages of them toward their respective faces and hence realizes, in a simplified manner, a natural and smooth conversation.

The face-to-face translator 10 acquires, as the content of a first voice, recognized text data (an example of the term “first text data”) obtained by character-recognizing the voice content of the uttered voice data, and acquires, as a translated content, translated text data (an example of the term “second text data”) obtained by translating the recognized text data into the language suitable for the host HST1 or the guest GST1. With this measure, the face-to-face translator 10 can properly present the content of a voice uttered by the host HST1 or the guest GST1 on the transparent screen 30 as text data and hence can effectively facilitates understanding of the voice like a telop (e.g., subtitle) used in a television broadcast, for example.

The face-to-face translator 10 further acquires, as a translated content, voice data of a second voice (e.g., translated voice data) obtained by translating the content of the uttered voice data into the language suitable for the host HST1 or the guest GST1. With this measure, by conveying not only the text but also an output sound to the counterpart, the face-to-face translator 10 can effectively convey, to the counterpart, the voice obtained by translating the voice uttered by the host HST1 or the guest GST1 into a language that can be understood by the counterpart and hence can help the counterpart to understand the content of the voice quickly.

The face-to-face translator 10 sends a projection instruction to the projector 20 so that the voice content of the uttered voice data can be presented on the transparent screen 30 in the form of outline characters in a first-shape frame (e.g., rectangular frame) that is painted out in a first color (e.g., light blue). For example, outline characters are characters that are made recognizable to the host HST1 on a rectangular frame that is “painted out” in light blue by removing only character portions and thereby making them appear. Outline characters are less recognizable than solid characters (described below). On the other hand, the face-to-face translator 10 sends a projection instruction to the projector 20 so that the voice content of the translated text data can be presented on the transparent screen 30 in the form of solid characters having a second color (e.g., white) in a transparent second-shape frame (e.g., rectangular frame). For example, solid characters are characters that are made recognizable to the guest GST1 on a transparent rectangular background frame by writing only character portions in white. Solid characters are more recognizable than outline characters (described above). With this measure, in the face-to-face translator 10, for example, a text of the content of a voice uttered by the host HST1 may presented to the host HST1 in the form of outline characters only for confirmation. On the other hand, a text written in solid characters that are more visible to the guest GST1 than in the case of outline characters can be presented to the guest GST1. In this manner, texts can be presented on the transparent screen 30 in favor of the guest GST1 so as to avoid confusion in recognition due to presentation of text data that can be understood by the two persons.

For example, the transparent presentation unit may be a touch panel (not shown) that can be manipulated by each of the host HST1 and the guest GST1 instead of being composed of the projector 20 and the transparent screen 30. The face-to-face translator 10 presents recognized text data (an example of the term “content of the first voice”) at a first presentation position and presents translated text data (an example of the term “translated content”) at a second presentation position on the touch panel on the basis of the first presentation position and the second presentation position specified by the host HST1 and the guest GST1, respectively. With this measure, the face-to-face translator 10 can display (present) recognized text data and translated text data on the touch panel at desired positions specified by the host HST1 and the guest GST1, respectively. That is, text data corresponding to their respective languages can be presented at such positions that the host HST1 and the guest GST1 can see each other's face easily and recognize each other during an actual conversation, for example, at positions located a little below their lines of sight.

The face-to-face translator 10 presents translated text data (an example of the term “translated content”) and recognized text data (an example of the term “content of the first voice”) on the transparent screen 30 in such a manner that the translated text data is located above the recognized text data. With this measure, for example, the face-to-face translator 10 can present the translated text data at a top-side position on the transparent screen 30 where the guest GST1 can see it more easily with preference given to the guest GST1 over the host HST1. That is, the texts can be on the transparent screen 30 in favor of the guest GST1.

The face-to-face translator 10 presents translated text data (an example of the term “translated content”) for a longer time than recognized text data (an example of the term “content of the first voice”) on the transparent screen 30. With this measure, for example, the face-to-face translator 10 can present, on the transparent screen 30, the translated text data to be viewed by the guest GST1 for a longer time than the recognized text data to be viewed by the host HST1 for confirmation with preference given to the guest GST1 over the host HST1. That is, the texts can be on the transparent screen 30 in favor of the guest GST1.

The face-to-face translator 10 presents translated text data (an example of the term “translated content”) on the transparent presentation 30 in a prescribed color (e.g., white) that is high in recognition rate. With this measure, since the face-to-face translator 10 allows the guest GST1 to see the translated text data that is projected onto the transparent screen 30 in the prescribed color (e.g., white), the guest GST1 can understand the content of the translated text data quickly.

For example, the transparent presentation unit is composed of the transparent screen 30 and the projector 20. The face-to-face translator 10 sends, to the projector 20, an instruction to project recognized text data (an example of the term “content of the first voice”) and translated text data (an example of the term “translated content”) onto the transparent screen 30. With this measure, the face-to-face translator 10 can present the recognized text data of a voice uttered by the host HST1 and the translated text data suitable for the guest GST1 on the transparent screen 30 in a simple manner.

For example, the transparent presentation unit is a touch panel (not shown) that can be manipulated by the host HST1 and the guest GST1. The face-to-face translator 10 sends recognized text data (an example of the term “content of the first voice”) and translated text data (an example of the term “translated content”) to the touch panel so that they are displayed on the touch panel. With this measure, even if equipped with neither the projector 20 nor the transparent screen, the face-to-face translator 10 allows the host HST1 and the guest GST1 to see the recognized text data and the translated text data in a state that they face each other with the touch panel interposed between them and hence can realize a natural conversation effectively.

In the first embodiment, the size of each of various text data (more specifically, recognized text data and translated text data) to be projected onto the transparent screen 30 is specified by the projector 20 and may be included in a projection instruction sent from the face-to-face translator 10, for example. With this measure, the face-to-face translator 10 can flexibly change the size of text data to be projected onto the transparent screen 30 according to, for example, an age range specified by a manipulation of the host HST1 or the guest GST1.

In the first embodiment, the transparent screen 30 is provided as an example of the transparent presentation unit. Thus, the language presentation system 100 can be used as a service tool in entertaining a special customer (e.g., guest GST1) by installing the transparent screen 30 at, for example, a place where a luxury environment can be produced (e.g., a selling area of cosmetic products in a department store or a reception counter of a premium train).

In the language presentation system 100 according to the first embodiment, the control unit 13 (an example of the term “acquisition unit”) of the face-to-face translator 10 acquires, together with the transparent screen 30 (an example of the term “transparent presentation unit”), a first voice (e.g., a voice included in uttered voice data) of a first language (e.g., Japanese) uttered by the host HST1 or the guest GST1. The control unit 13 of the face-to-face translator 10 present the content of the acquired first voice and a translated content obtained by translating the content of the first voice into a second language (e.g., English) that is different from the first language on the transparent screen 30 directly or via the projector 20 in such a manner that they are inverted from each other in the left-right direction.

With this measure, the face-to-face translator 10 can present the content of a voice of a first language (e.g., Japanese) uttered by one user (e.g., the host HST1 who speaks Japanese) and a translated content obtained by translating the content of that voice into a second language (e.g., English) that is suitable for the other user (e.g., the guest GST1 who speaks English) on the transparent screen 30 in such a manner that they are inverted from each other in the left-right direction. Thus, when, for example, two persons who cannot understand each other's language make a conversation, each of them can see a text of his or her own language and a text of the other person's language while looking at the other person's face. As a result, a natural and smooth conversation can be realized in a simplified manner.

Although the embodiment has been described above with reference to the accompanying drawings, it goes without saying that the disclosure is not limited to that example. It is apparent that those skilled in the art could conceive various changes, modifications, replacements, additions, deletions, or equivalents within the confines of the claims, and they are construed as being included in the technical scope of the disclosure. And constituent elements of the above-described various embodiments can be combined in a desired manner without departing from the spirit and scope of the invention.

Incidentally, in the language presentation system 100 according to the first embodiment, the table TBL1 on which the transparent screen 30 is installed is not limited to a table placed on a counter (see FIG. 2) and may be, for example) a table (not shown) that is connected to a stand-attached pole that can be moved being gripped by a person. With this measure, the manner of use is not limited to a case that the host HST1 and the guest GST1 drops in at a particular, restricted position and make a conversation and the conversation place of the host HST1 and the guest GST1 can be changed in a desired manner because of increased mobility of the transparent screen 30.

Although the above-described first embodiment is directed to the case that the host HST1 and the guest GST1 make a conversation facing each other with the transparent screen (installed on the counter such as a reception counter) interposed between them, the place where the transparent screen is installed is not limited to a counter such as a reception counter and may be a taxi, a restaurant, a conference room, an information office of a train station, etc. For example, a transparent glass plate provided between the driver seat and the rear seat in a taxi can be used as the transparent screen 30. In a restaurant, a conference room, or an information office of a train station, the transparent screen 30 may be provided between persons who face each other and make a conversation.

The above-described language presentation system 100 according to the first embodiment can be applied to what is called finger-pointing translation in which text data of each other's language is displayed on a touch panel or the like.

The present application is based on Japanese Patent Application No. 2018-013425 filed on Jan. 30, 2018, the disclosure of which is invoked herein by reference.

### INDUSTRIAL APPLICABILITY

The present disclosure is useful when applied to language presentation devices, language presentation methods, and language presentation programs that allow two persons who cannot understand each other's language to make a conversation while continuing to look at each other's face by presenting languages of them toward their respective faces and thereby realize, in a simplified manner, a natural and smooth conversation.

### DESCRIPTION OF SYMBOLS

10: Face-to-face translator
11, 51: Communication unit
12, 52: Memory
13: Control unit
14, 54: Storage unit
20: Projector
30: Transparent screen
53: Translation control unit
MC1: Microphone
NW: Network
PRC1, PRC2: Processor
SP1: Speaker
SW1, SW2: Switch
100: Language presentation system

1. A language presentation device comprising:
a first acquisition unit configured to acquire a first voice uttered by at least one of a first user and a second user who are located with a transparent presentation unit interposed between the first user and the second user;
a second acquisition unit configured to acquire a content of the acquired first voice and a translated content obtained by translating the content of the first voice into a language suitable for the first user or the second user; and
a control unit configured to present the acquired content of the first voice and the acquired translated content on the transparent presentation unit in such a manner that one of the acquired content of the first voice and the acquired translated content is inverted in a left-right direction.

2. The language presentation device according to claim 1, wherein the second acquisition unit is configured to:
acquire, as the content of the first voice, first text data obtained by character-recognizing the content of the first voice; and
acquire, as the translated content, second text data obtained by translating the first text data into the language.

3. The language presentation device according to claim 1, wherein the second acquisition unit is configured to further acquire voice data of the translated content obtained by translating the content of the first voice into the language.

4. The language presentation device according to claim 1, wherein the control unit is configured to:
present, on the transparent presentation unit, the content of the first voice in the form of outline characters on a first-shape frame that is painted out in a first color; and
present, on the transparent presentation unit, the translated content in the form of solid characters having a second color in a transparent second-shape frame.

5. The language presentation device according to claim 1, wherein the transparent presentation unit is configured by a touch panel that can be manipulated by each of the first user and the second user; and
wherein the control unit is configured to present the content of the first voice at a first presentation position and present the translated content at a second presentation position based on the first presentation position and the second presentation position on the touch panel specified by the first user and the second user, respectively.

6. The language presentation device according to claim 1, wherein the control unit is configured to present the content of the first voice and the translated content on the transparent presentation unit in such a manner that the translated content is located above the content of the first voice.

7. The language presentation device according to claim 1, wherein the control unit is configured to present the translated content for a longer time than the content of the first voice.

8. The language presentation device according to claim 1, wherein the control unit is configured to present the translated content on the transparent presentation unit with a prescribed color that is high in recognition rate.

9. The language presentation device according to claim 1, wherein the transparent presentation unit is configured by a transparent screen and a projector; and
wherein the control unit is configured to send, to the projector, an instruction to project the content of the first voice and the translated content onto the transparent screen.

10. The language presentation device according to claim 1, wherein the transparent presentation unit is configured by a touch panel that can be manipulated by the first user and the second user, respectively; and
wherein the control unit is configured to send the content of the first voice and the translated content to the touch panel so that the content of the first voice and the translated content are displayed on the touch panel.

11. A language presentation method employed in a language presentation device that serves for a conversation between a first user and a second user located with a transparent presentation unit interposed between the first user and the second user, the language presentation method comprising the steps of:
acquiring a first voice uttered by at least one of a first user and a second user;
acquiring a content of the acquired first voice and a translated content obtained by translating the content of the first voice into a language suitable for the first user or the second user; and
presenting the acquired content of the first voice and the acquired translated content on the transparent presentation unit in such a manner that one of the acquired content of the first voice and the acquired translated content is inverted in a left-right direction.

12. A language presentation program for causing a language presentation device that is a computer and serves for a conversation between a first user and a second user located with a transparent presentation unit interposed between the first user and the second user to execute the steps of:
acquiring a first voice uttered by at least one of a first user and a second user;
acquiring a content of the acquired first voice and a translated content obtained by translating the content of the first voice into a language suitable for the first user or the second user; and
presenting the acquired content of the first voice and the acquired translated content on the transparent presentation unit in such a manner that one of the acquired content of the first voice and the acquired translated content is inverted in a left-right direction.

13. A language presentation device comprising:
a transparent presentation unit;
an acquisition unit configured to acquire a first voice uttered by a user in a first language; and
a control unit configured to present a content of the acquired first voice and a translated content obtained by translating the content of the first voice into a second language that is different from the first language on the transparent presentation unit in such a manner that the content of the acquired first voice and the translated content are inverted from each other in a left-right direction.

14. A language presentation program for causing a language presentation device that is a computer connected to a transparent presentation unit to execute the steps of:
acquiring a first voice uttered by a user in a first language;
acquiring a content of the acquired first voice and a translated content obtained by translating the content of the first voice into a second language that is different from the first language; and
presenting the acquired content of the first voice and the acquired translated content on the transparent presentation unit in such a manner that the content of the acquired first voice and the translated content are inverted from each other in a left-right direction.
